(19) United States
(12) Patent Application Publication
(10) Pub. No.: US 2026/0246803 A1
(43) Pub. Date: Aug. 20, 2026

(54) INFORMATION PROCESSING METHOD, INFORMATION PROCESSING APPARATUS, AND NON-TRANSITORY STORAGE MEDIUM STORING PROGRAM

(71) Applicant: Panasonic Intellectual Property Management Co., Ltd., Osaka (JP)

(72) Inventors: HAJIME TASAKI, Osaka (JP); MOE YOSHIDA, Osaka (JP); MANABU MAEDA, Osaka (JP)

(21) Appl. No.: 19/646,671

(22) Filed: Apr. 14, 2026

Related U.S. Application Data
(63) Continuation of application No. PCT/JP2024/023862, filed on Jul. 2, 2024.

(30) Foreign Application Priority Data
Nov. 16, 2023 (JP) 2023-195348

(51) Int. Cl. H04L 9/40

(52) U.S. Cl. CPC H04L 63/1425

(57) ABSTRACT

An information processing method includes classifying a log of a device into one of a plurality of groups based on a device status that indicates a state of the device controlled by a command included in a communication packet and detecting a low-and-slow attack for each group of the plurality of groups based on one or more logs classified into the group.

### BACKGROUND

### 1. Technical Field

The present disclosure relates to an information processing method, an information processing apparatus, and a non-transitory storage medium storing a program.

### 2. Description of the Related Art

Apparatus for detecting anomalies in communications, such as cyber attacks, have been developed (refer to, for example, Japanese Unexamined Patent Application Publication No. 2019-21294).

Japanese Unexamined Patent Application Publication No. 2019-21294 describes a system for detecting a distributed denial-of-service attack (DDoS attack). More specifically, the system described in Japanese Unexamined Patent Application Publication No. 2019-21294 receives, from a first user, one or more requests for a service executed on a server and generates a first vector corresponding to the first user. The first vector includes a plurality of features representing the first user accessing the service. The system then determines that the service is under a denial-of-service attack based on a comparison of the first vector and a reference vector including an average distribution of features of the plurality of users accessing the service.

### SUMMARY

One type of cyber attack is a low-and-slow attack. It is desirable to detect such attacks as well.

One non-limiting and exemplary embodiment provides an information processing method or the like for detecting a low-and-slow attack.

In one general aspect, the techniques disclosed here feature an information processing method that includes classifying a log of a device into one of a plurality of groups based on a device status that indicates a state of the device controlled by a command included in a communication packet and detecting a low-and-slow attack for each group of the plurality of groups based on one or more logs classified into the group.

According to the present disclosure, it is possible to provide an information processing method or the like for detecting a low-and-slow attack.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates the configuration of a communication system according to an embodiment;

FIG. 2 is a block diagram of the functional configuration of a home appliance server according to the embodiment;

FIG. 3 illustrates an example of a home appliance log table according to the embodiment;

FIG. 4 illustrates an example of a communication log set table according to the embodiment;

FIG. 5 illustrates an example of an access information table according to the embodiment;

FIG. 6 illustrates an example of a log classification rule according to the embodiment;

FIG. 7 illustrates an example of an attack detection result table according to the embodiment;

FIG. 8 is a sequence diagram of the processing procedure of the communication system according to the embodiment;

FIG. 9 illustrates a flowchart illustrating the processing procedures of the home appliance server according to the embodiment;

FIG. 10 illustrates a flowchart of a processing procedure for detecting a low-and-slow attack performed by the home appliance server according to the embodiment; and

FIG. 11 illustrates a flowchart of an information processing method according to the embodiment.

### DETAILED DESCRIPTIONS

### Underlying Knowledge Forming Basis of the Present Disclosure

Conventionally, servers (server apparatuses) such as data servers that collect logs related to authentication or operation of household electrical appliances (hereinafter simply referred to as home appliances) have been monitored for anomalies. For example, detection and protection against cyber attacks, including a low-and-slow attack, are necessary to prevent leakage of the server configurations and other information to the outside.

A low-and-slow attack is an attack that attempts to cause a service outage, for example, a DoS attack, or to perform reconnaissance (reconnaissance action). One characteristic of a low-and-slow attack is that it involves a small amount of communication traffic.

Low-and-slow attacks include two types: a slow DoS attack and a slow scan attack.

A slow DoS attack is a malicious attempt that exploits repeated connection retries during communication with a server to exhaust server connection resources, without increasing communication traffic and the like, by intentionally delaying session establishment.

A slow scan attack is a malicious attempt that performs scanning on a target within normal communication traffic. Because a slow scan attack simulates normal communication, it produces only a small amount of communication traffic per day over a long duration and therefore does not itself cause server failures or other damage. However, since this attack is a reconnaissance attack, if the server configuration is exposed, it may serve as a basis for further attacks.

In addition, the contents of the communication in a slow scan attack, such as communication packets, are generally not considered anomalies. Therefore, it has conventionally been difficult to detect such an attack.

To detect a low-and-slow attack, for example, a possible method is to observe the number of communication packets and communication frequency per day for each source IP (Internet Protocol) address. In this method, if indications of a low-and-slow attack are observed over an extended period, it is determined that a low-and-slow attack is occurring.

However, such a method requires monitoring of communications over a long period of time, such as half a month. In addition, in such a method, it is determined, for each source IP address, whether communication corresponds to a low-and-slow attack. Therefore, the IP address must remain unchanged for each transmission source during the communication monitoring period.

There exists communication in which the transmission source is anonymous (hereinafter simply referred to as anonymous communication), such as a VPN (Virtual Private Network) connection. In anonymous communications, for example, a communication packet (hereinafter simply referred to as a packet) from the transmission source is forwarded to the transmission destination via a VPN server or the like. In anonymous communication, when a packet is delivered via a VPN server, the IP address of the packet is set to the IP address of the VPN server. Therefore, at the destination, the packet appears to originate from the VPN server, and the original source IP address cannot be identified.

When the VPN server used by a transmission source changes, the source IP address appears to change, rendering long-term tracking by IP address difficult. In addition, when the same VPN server is used by a plurality of transmission sources, it becomes difficult to distinguish between the transmission sources because the source IP addresses appear identical to the destination. If these transmission sources cannot be distinguished, it appears as though the plurality of communications originate from the same transmission source. Therefore, even if an attacker is conducting a low-and-slow attack among a plurality of transmission sources, it is difficult to detect that the attacker's communications correspond to a low-and-slow attack characterized by low communication traffic.

Accordingly, as a result of intensive study, the present inventors have found that a low-and-slow attack can be detected by using logs of a device serving as a transmission-destination device in communications.

Exemplary embodiments are described in detail below with reference to the accompanying drawings.

Note that each of the embodiments described below is a general or specific example of the present disclosure. A value, a shape, a material, a constituent element, the positions and the connection form of the constituent elements, steps, and the sequence of steps described in the embodiments below are only examples and shall not be construed as limiting the scope of the present disclosure. In addition, among the constituent elements in the embodiments described below, the constituent element that does not appear in an independent claim is described as an optional constituent element. All the drawings are schematic and not necessarily to scale. The same reference numerals are used throughout the accompanying drawings to refer to substantially the same constituent elements, and duplicate descriptions may be eliminated or simplified.

When described herein, unless otherwise specified, ordinal numerals such as "first" and "second" are not intended to denote number of elements or any particular order of the element, but are merely used to distinguish one element from another of a similar kind.

When described herein, expressions of contrast such as "greater than a threshold" and "less than or equal to a threshold" are intended to distinguish two values with respect to the threshold, and the expressions may be interpreted as "greater than or equal to the threshold" and "less than the threshold", respectively.

### EMBODIMENTS

### Configuration

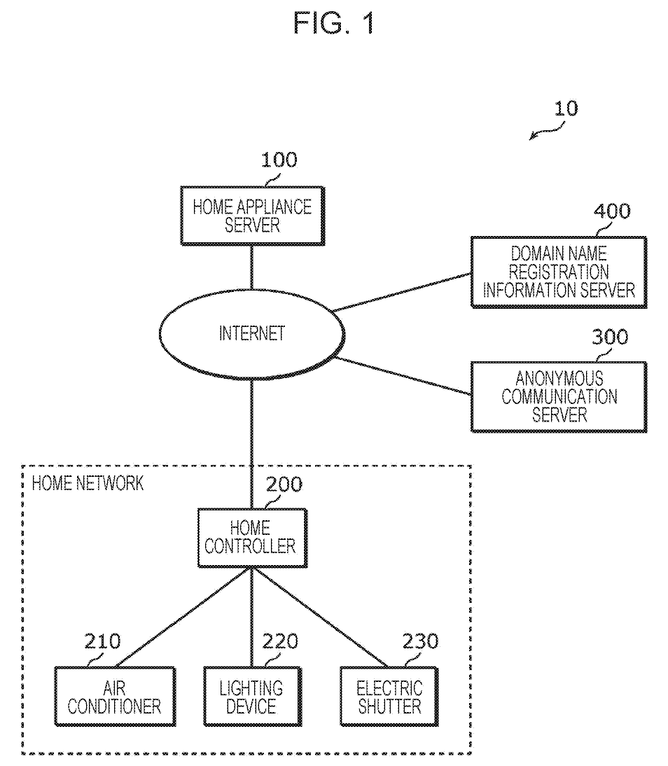

FIG. 1 illustrates the configuration of a communication system 10 according to the present embodiment.

The communication system 10 controls home appliances such as an air conditioner 210, a lighting device 220, and an electric shutter 230. The communication system 10 includes a home appliance server 100, a home controller 200, the air conditioner 210, the lighting device 220, the electric shutter 230, an anonymous communication server 300, and a domain name registration information server 400.

The home appliance server 100 is a computer that acquires and stores home appliance logs. The home appliance server 100 is communicatively connected over the Internet to the home controller 200, the anonymous communication server 300, and the domain name registration information server 400. The home controller 200 is connected to a home network (i.e., a local network) used in a residence or the like. The home network is a communication network that communicatively connects the home controller 200 and the home appliances, through either wireless or wired connections.

The home controller 200 monitors, for example, the state of the home appliance (device status). When the home appliance is operated and the device status changes, the home controller 200 transmits a log to the home appliance server 100 over the Internet. The log includes the changed device status, the device type of the home appliance, the device ID serving as a unique identifier of the home appliance, and an operation command for the home appliance (hereinafter also simply referred to as a command).

The home controller 200 receives a packet including a command from a transmission source, such as a smartphone or other computer used by a user, and controls the home appliance based on the command included in the received packet. The home controller 200 may receive the packet directly from the transmission source or through a device such as the anonymous communication server 300.

The anonymous communication server 300 is a computer that forwards a packet received from a transmission source to a transmission destination so that the source of the packet cannot be identified. That is, the anonymous communication server 300 is a computer that anonymizes the transmission source of a packet and forwards the packet to the transmission destination. The anonymous communication server 300 forwards a packet received from the transmission source to the transmission destination using its own IP address, for example. This makes the source of the packet appear to the receiving computer as the anonymous communication server 300.

The domain name registration information server 400 is a computer that stores registration information including an IP address and a domain name associated with the IP address. The domain name registration information server 400 is, for example, a server that provides WHOIS service. The home appliance server 100 determines whether the IP address of a packet is the IP address of the anonymous communication server 300, for example, by querying the domain name registration information server 400.

The home appliance server 100, the home controller 200, the anonymous communication server 300, and the domain name registration information server 400 each is configured with a communication interface for communicating with each other, a nonvolatile memory in which a program is stored, a volatile memory serving as a temporary storage area for executing the program, an I/O port for transmitting and receiving a signal, and a processor that executes the program. The communication interface may be configured, for example, with an antenna and a wireless communication circuit for wireless communication, or with a connector for connecting a communication line for wired communication.

The home appliances, such as the air conditioner 210, the lighting device 220, and the electric shutter 230, that are communicatively connected to the home controller 200 are merely examples, and may include any home appliance, such as an electric lock or a water heater. The number of home appliances connected to the home network may be one or more. The air conditioner 210, the lighting device 220, and the electric shutter 230 are merely examples of devices. The home appliances that are communicatively connected to the home controller 200 are, for example, IoT (Internet of Things) devices.

The communication standard for communication between the home controller 200 and each of the home appliances (i.e., the communication standard for the home network) may be any standard. Wi-Fi (registered trademark), Bluetooth (registered trademark), or other communication standards may be used. These home appliances may also be controlled (i.e., operated) via the Internet.

The anonymous communication server 300 is, for example, a server apparatus that performs communications using a VPN connection; however the anonymous communication server 300 needs only to anonymize a packet by any method so that the source IP address cannot be identified.

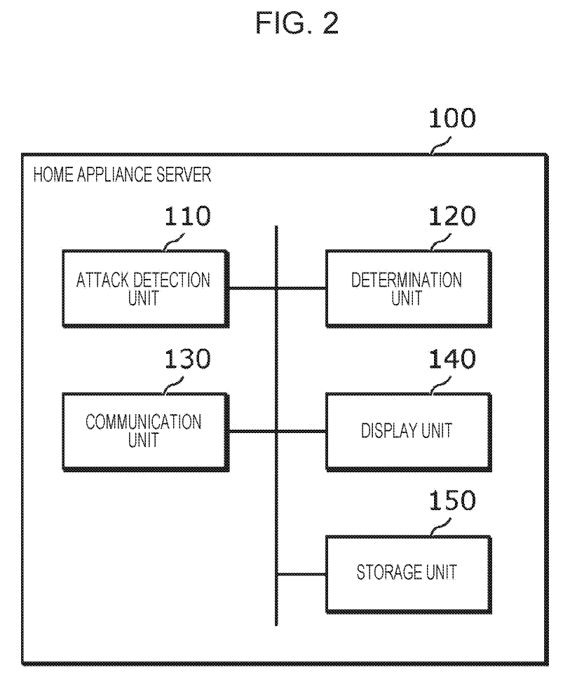

FIG. 2 is a block diagram of the functional configuration of the home appliance server 100 according to the present embodiment.

The home appliance server 100 includes an attack detection unit 110, a determination unit 120, a communication unit 130, a display unit 140, and a storage unit 150.

The attack detection unit 110 is a processing unit that detects a server attack. More specifically, the attack detection unit 110 detects a low-and-slow attack. The attack detection unit 110 is an example of a detector.

The determination unit 120 is a processing unit that classifies the home appliance logs. More specifically, the determination unit 120 is a processing unit that classifies the home appliance logs into one of a plurality of groups based on the device status of the home appliance, which is controlled in accordance with a command included in the packet. The packet is transmitted to the home controller 200 to control a home appliance such as the air conditioner 210, the lighting device 220, or the electric shutter 230. The determination unit 120 is an example of a classifier.

According to the present embodiment, the determination unit 120 acquires a home appliance log and classifies the log into one of a plurality of communication log sets based on the device status of the home appliance (more specifically, information indicating the device status) included in the acquired home appliance log. More specifically, the determination unit 120 classifies the log by determining whether a set of logs (also referred to as a communication log set) similar to the acquired home appliance log exists based on the device status and associating a communication log set ID with the log. A communication log set is an example of a group.

For example, upon receipt of a log from the home controller 200, the determination unit 120 determines, based on the device status included in the received log, whether a log similar to the received log exists in a log set previously generated. If the determination unit 120 determines that a log similar to the received log exists, the determination unit 120 adds the received log to the communication log set including the similar log. For example, the determination unit 120 associates the received log with a communication log set ID, which is an ID of the communication log set that includes the similar log, so that the received log and the similar log are included in the same communication log set. If the determination unit 120 determines that no log similar to the received log exists, the determination unit 120 generates a new communication log set by assigning a new communication log set ID to the received log.

For example, the determination unit 120 first classifies the acquired home appliance log based on the IP address. The determination unit 120 further determines whether the packet was transmitted through anonymous communication. That is, the determination unit 120 determines whether the packet was transmitted through, for example, the anonymous communication server 300. For example, if the determination unit 120 determines that the packet was transmitted through anonymous communication, the determination unit 120 further classifies the home appliance log based on the device status.

The attack detection unit 110 detects a low-and-slow attack based on the classified home appliance logs. More specifically, the attack detection unit 110 detects a low-and-slow attack for each of the plurality of groups based on one or more logs classified into the group. According to the present embodiment, the attack detection unit 110 detects a low-and-slow attack for each communication log set, that is, for each group into which similar home appliance logs are classified by the determination unit 120. More specifically, for each communication log set, the attack detection unit 110 determines whether one or more logs in the communication log set are home appliance logs controlled by communication intended for a low-and-slow attack. Thus, for each group into which similar home appliance logs are classified, the attack detection unit 110 detects a low-and-slow attack based on one or more classified home appliance logs.

For example, in the detection of a low-and-slow attack (detection process), the attack detection unit 110 determines, for each of the plurality of communication log sets, based on one or more logs in the log set, whether a low-and-slow attack has occurred, whether an indication of such an attack exists, or whether a low-and-slow attack has not occurred. For example, in the detection of a low-and-slow attack, the attack detection unit 110 detects, for each of the plurality of communication log sets, whether such an attack has occurred based on at least one of the average number of accesses to the home appliance per day, the number of consecutive days of access to the home appliance, or the access frequency to the home appliance, which are calculated from the one or more logs in the communication log set.

As used herein, the term "access to a home appliance" refers to transmission of a packet for controlling the home appliance. According to the present embodiment, the reception, by the home controller 200, of a packet including a command for controlling a home appliance is also referred to as access to the home appliance.

The earliest access day to the home appliance is the first day on which the home appliance was controlled in one or more logs classified in the same group, i.e., in one or more logs associated with the same communication log set ID. According to the present embodiment, the day corresponds to the day on which the home appliance first performed control based on a command included in the packet received by the home controller 200 in one or more logs classified in the same group.

The average number of accesses is obtained by dividing the total number of accesses from the earliest access day to the home appliance to the day on which the average number of accesses is calculated by the number of days during that period (the number of communication days).

The number of consecutive days of access is the number of days on which control of the home appliance has been continuously performed in one or more logs classified in the same group. For example, the number of consecutive days is incremented by one on each day that the home appliance is accessed. For example, to calculate the number of consecutive days of access, if the home appliance is controlled on a given day, the number of consecutive days of access is incremented by one compared to the previous day; if the home appliance is not controlled, the number of consecutive days of access is not incremented. In addition, to calculate the number of consecutive days of access, if the home appliance is not controlled for a second period of time (e.g., one month) in one or more logs classified in the same group, the number of consecutive days of access is reset to 0. For example, to calculate the number of consecutive days of access, if the home appliance is controlled on the day on which the number of consecutive days of access is calculated and the number of consecutive days of access was 2 on the previous day, the number of consecutive days of access is incremented to 3. However, to calculate the number of consecutive days of access, if the home appliance is not controlled on the day on which the number of consecutive days of access is calculated and the number of consecutive days of access was 2 on the previous day, the number of consecutive days of access remains at 2. Furthermore, to calculate the number of consecutive days of access, if the number of consecutive days of access was 10 as of one month ago and the home appliance has not been controlled from that day until the day on which the number of consecutive days of access is calculated, the number of consecutive days of access is reset to zero.

The access frequency is defined as the frequency at which the home appliance was controlled, as recorded in one or more logs classified in the same group. The access frequency is calculated, for example, such that, for each day, the access frequency on the previous day is incremented by one if the home appliance is controlled on that day, and remains unchanged if the home appliance is not controlled. In addition, to calculate the access frequency, if the home appliance has not been controlled for, for example, a first period of time, such as three days, in one or more logs classified in the same group, the calculated access frequency is decremented by one. For example, to calculate the access frequency, if the access frequency on the previous day was 2, the access frequency is updated to 3 when the home appliance is controlled on the day of calculation. However, to calculate the access frequency, if the access frequency on the previous day was 2, the access frequency remains at 2 when the home appliance is not controlled on the day of calculation. Furthermore, if the access frequency was 2 as of three days ago and the home appliance has not been controlled during the period from that day until the day of calculation, the access frequency is updated to 1 accordingly.

The values used for addition or subtraction described above, the first period of time, and the second period of time are merely examples, and any values may be alternatively used. For example, the second period of time is set to a number of days greater than the first period of time.

For example, in detection of a low-and-slow attack, the attack detection unit 110 determines that a low-and-slow attack has not occurred if the average number of accesses is greater than a first threshold value. Alternatively, in detection of a low-and-slow attack, for example, the attack detection unit 110 determines that a low-and-slow attack has not occurred if the number of consecutive days of access is less than or equal to a second threshold value.

However, in detection of a low-and-slow attack, for example, the attack detection unit 110 determines whether a low-and-slow attack has occurred or whether an indication of such an attack exists when the average number of accesses is less than or equal to the first threshold value and the number of consecutive days of access is greater than the second threshold value. For example, in detection of a low-and-slow attack, the attack detection unit 110 determines that a low-and-slow attack has occurred if the access frequency is greater than a third threshold value. However, in detection of a low-and-slow attack, for example, the attack detection unit 110 determines that an indication of a low-and-slow attack exists when the access frequency is less than or equal to the third threshold value.

The first, second, and third threshold values may be determined to be any values and are not limited to particular values.

Each of the processing units, such as the attack detection unit 110 and the determination unit 120, may be implemented by a memory and a processor, e.g., a central processing unit (CPU), that executes a control program stored in the memory. The memories of these processing units may be implemented as a shared memory or as one or more independent memories. The processors of these processing units may be implemented as a processor shared among the processing units or as one or more independent processors provided in each processing unit.

The communication unit 130 is a communication interface for communicating with the home controller 200, the anonymous communication server 300, and the domain name registration information server 400. The communication unit 130 may be implemented, for example, by an antenna and a wireless communication circuit to enable wireless communication, or by a connector to which a communication line is connected.

The display unit 140 is a device for displaying an image. The display unit 140 displays, for example, the detection result of the attack detection unit 110.

The storage unit 150 is a device for storing various types of information. The storage unit 150 is implemented by a storage device such as a semiconductor memory or a hard disk drive (HDD). The storage unit 150 stores, for example, the threshold values and the home appliance logs described above. The storage unit 150 stores, for example, a home appliance log table, a communication log set table, an access information table, information indicating a log classification rule, and an attack detection result table (described below). The storage unit 150 may store the IP address and/or domain name of the anonymous communication server 300.

### Specific Examples

Specific examples of the various types of information are described below.

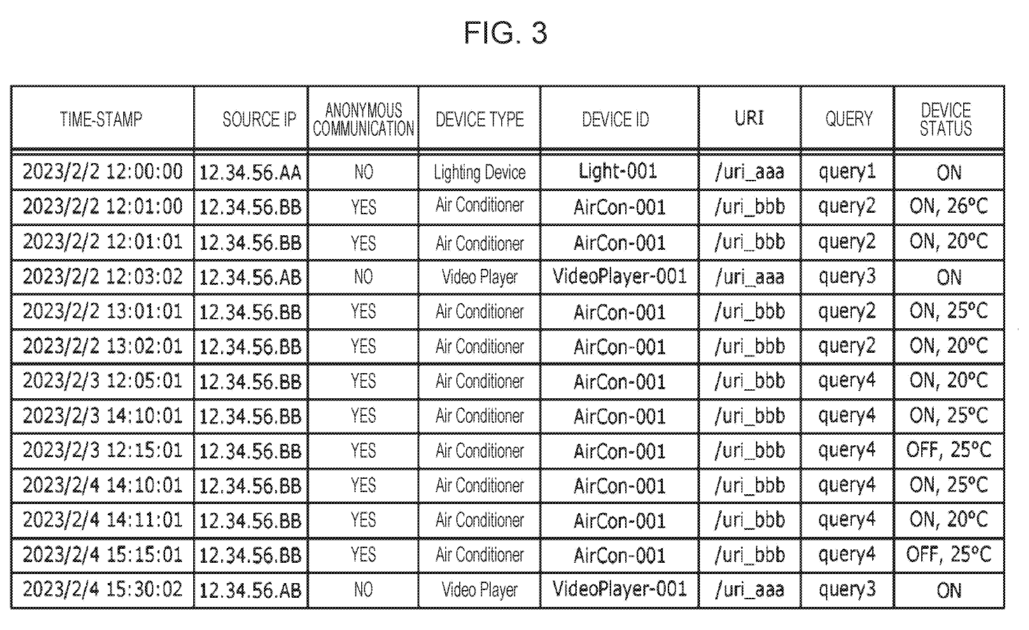

FIG. 3 illustrates an example of the home appliance log table according to the present embodiment.

The home appliance log table is information containing home appliance logs transmitted from the home controller 200 to the home appliance server 100. The determination unit 120 generates or updates the home appliance log table, for example, upon receipt of a log via the communication unit 130. The log is transmitted from the home controller 200 to the home appliance server 100, for example, each time the home appliance device status changes. For example, upon a change in its device status, the home appliance transmits a log including the device status to the home controller 200. The home controller 200 transmits a log including the received device status to the home appliance server 100.

The log transmitted from the home controller 200 to the home appliance server 100 contains, for example, information indicating a time stamp, a source IP, the device type, the device ID, URI (Uniform Resource Identifier), a query, and the device status. The home appliance log table includes, for example, the above-described information contained in the log and information indicating whether anonymous communication is employed (see "Anonymous Communication" in FIG. 3).

The time-stamp represents the date and time at which the home appliance is controlled to enter the device status associated with the time-stamp.

The source IP represents the IP address of the transmission source of the packet including the command for controlling the home appliance to enter the device status associated with the source IP.

The device type represents the type of controlled home appliance.

The device ID represents an identifier that uniquely identifies the controlled home appliance.

The URI serves as an identifier of the log transmitted from the home controller 200 to the home appliance server 100.

The query represents the variable appended to the URI.

The device status indicates the state of the home appliance after being controlled, i.e., information indicating the details of the control applied to the home appliance.

The information indicating whether anonymous communication is employed indicates whether a packet including a command for controlling the home appliance was transmitted through anonymous communication. For example, the determination unit 120 communicates with the domain name registration information server 400 via the communication unit 130 to inquire whether the source IP is the IP address of the anonymous communication server 300. Based on the communication result, the determination unit 120 determines whether the source IP is the IP address of a packet transmitted through anonymous communication, i.e., whether the source IP is the IP address of the anonymous communication server 300. Furthermore, the determination unit 120 stores the determination result in the storage unit 150 so that the determination result is recorded in the home appliance log table. In the example illustrated in FIG. 3, when "Anonymous Communication" is "No", the source IP does not correspond to the IP address of the anonymous communication server 300, whereas when "Anonymous Communication" is "Yes", the source IP corresponds to the IP address of the anonymous communication server 300.

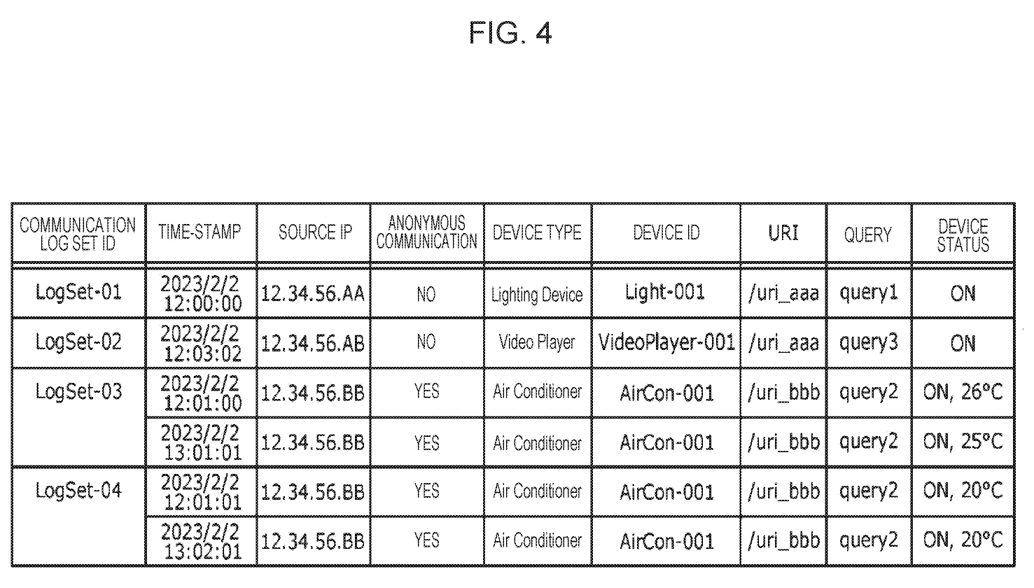

FIG. 4 illustrates an example of the communication log set table according to the present embodiment.

The communication log set table includes the communication log set IDs each being associated with one or more logs. That is, the communication log set table indicates a set of groups of similar logs. A communication log set is, for example, a set of logs obtained during a predetermined period of time (e.g., one day). The determination unit 120 manages the logs by assigning one of the communication log set IDs to a log. The communication log set ID is used as identification information when information regarding a low-and-slow attack is managed using the access information table (described below). The device information set in each communication log set is referenced and used to distinguish the transmission source when anonymous communication is used to access a home appliance. For example, for an access through anonymous communication, the determination unit 120 identifies the transmission source based on the device status of the home appliance and determines the communication log set for detecting a low-and-slow attack.

The predetermined period of time may be set to any period of time (e.g., one week or one month).

The determination unit 120, for example, generates or updates a communication log set table based on the home appliance log table. For example, the determination unit 120 classifies each log included in the home appliance log table based on the source IP. In addition, the determination unit 120 further classifies the logs based on source IP into device types when "Anonymous Communication" is set to "YES". Furthermore, the determination unit 120 classifies the logs based on device type into device IDs. Moreover, the determination unit 120 further classifies the logs based on device ID into respective device statuses. A specific example of the classification method is described later.

The determination unit 120 may classify the logs based on device type, device ID, and device status, or refrain from such classification, when "Anonymous Communication" is "NO".

Based on the communication log set table, the determination unit 120 calculates the average number of accesses, the access frequency, the number of consecutive days of access, and the total number of accesses for each log associated with the same communication log set ID.

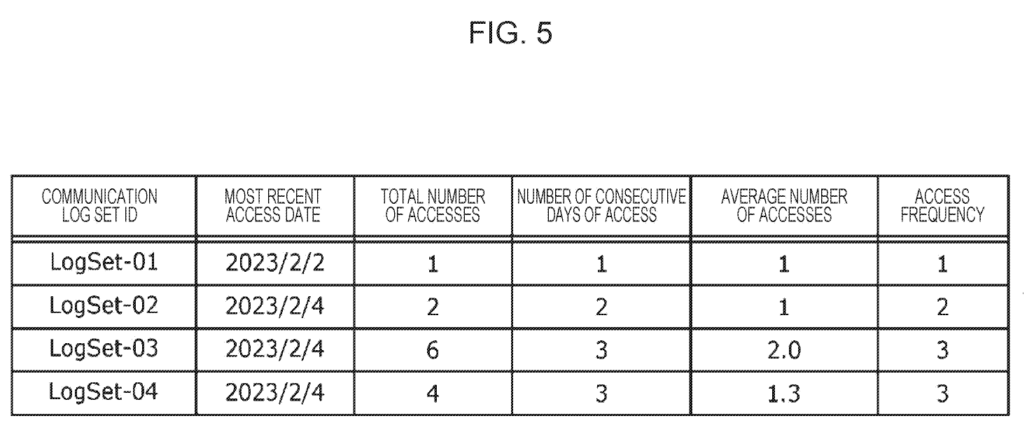

FIG. 5 illustrates an example of the access information table according to the present embodiment.

The access information table includes the most recent access date, the total number of accesses, the number of consecutive days of access, the average number of accesses, and the access frequency (collectively referred to as access information) for each communication log set.

The most recent access date is the most recent date on which the home appliance was controlled in one or more logs associated with the same communication log set ID, i.e., the most recent date on which the home appliance was accessed. The most recent access date is used, for example, to calculate the number of days elapsed since the previous access date (i.e., the access date immediately preceding the most recent access date) in the process of calculating the access frequency for detecting a low-and-slow attack. The determination unit 120 updates the most recent access date in the access information table when a new access to the home appliance occurs. The determination unit 120 generates or updates the access information table based on the communication log set table.

For example, at the end of a day (e.g., between 23:00 and 24:00), the determination unit 120 associates the communication log set IDs with a log received on that day and calculates the average number of accesses, the access frequency, the number of consecutive days of access, and the total number of accesses. In addition, the determination unit 120 updates the access information table using the calculation results.

For example, the determination unit 120 updates the number of consecutive days of access in the access information table by adding a value (e.g., 1) for each day on which the home appliance is accessed.

An average number of accesses stored in the access information table represents the average number of accesses as of the previous access date. For example, when calculating a new average number of accesses for low-and-slow attack detection, the determination unit 120 references the average number of accesses stored in the access information table and updates it.

The access frequency stored in the access information table represents the access frequency up to the previous access date. For example, in calculating a new access frequency for low-and-slow attack detection, the determination unit 120 references the access frequency and updates it.

The total number of accesses stored in the access information table represents the cumulative number of accesses since the first access day (i.e., the date of generation of the communication log set). The determination unit 120 resets the total number of accesses (i.e., reset to 0) when the home appliance has not been accessed for a predetermined period of time, e.g., one month.

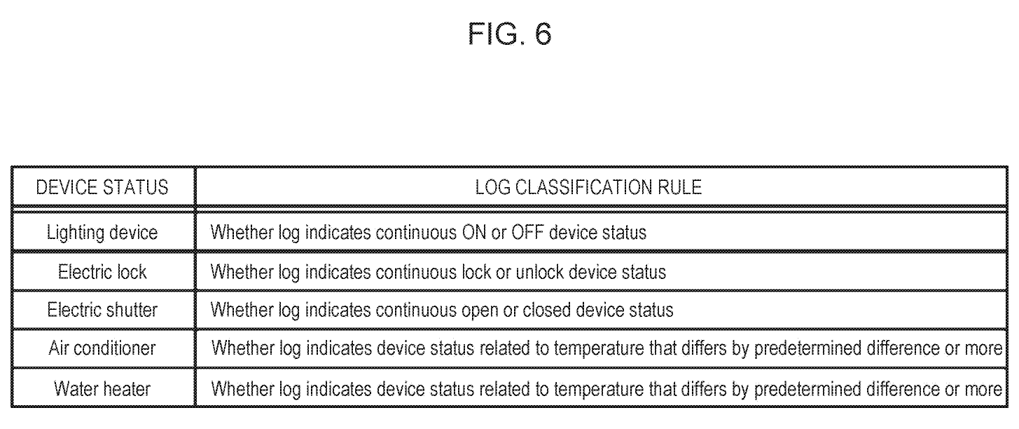

FIG. 6 illustrates an example of the log classification rule according to the present embodiment.

The log classification rule is used by the determination unit 120 to classify logs. That is, the log classification rule is used for associating a communication log set ID with a log. For example, the determination unit 120 classifies (divides) a plurality of acquired logs into a plurality of communication log sets based on the log classification rule. The log classification rule is used to distinguish between low-and-slow attack communication and legitimate communication based on the device status when a home appliance is accessed through anonymous communication. The log classification rule is associated with a device type and is determined according to the characteristics of a home appliance. Information representing the log classification rules corresponding to each device type, as illustrated in FIG. 6, is generated in advance and, for example, stored in the storage unit 150.

The classification of logs using the log classification rules is performed so that the same communication log set ID is associated with the logs having similar device status. In the example illustrated in FIG. 6, when the device type is "lighting device", the device status (or the command to set the device to that status) indicates, for example, the ON status (illuminated status) or the OFF status (unilluminated status). In the present example, the determination unit 120 classifies the logs such that, when the device type is "lighting device", different communication log set IDs are assigned depending on whether the ON status or OFF status indicated by the device status of the log is the same as or different from the device status of the immediately preceding log. That is, for example, the determination unit 120 classifies each log into a category indicating that control was continuously performed to maintain the same device status or a category indicating that control was performed to change the device status.

When the device type is "electric lock", the device status indicates, for example, a locked status or an unlocked status. Furthermore, when the device type is "electric shutter", the device status indicates, for example, an open status or a closed status. In the present example, like "lighting device", even when the device type is "electric lock" or "electric shutter", the determination unit 120 classifies each log into a category indicating that control was continuously performed to maintain the same device status or a category indicating that control was performed to change the device status.

Furthermore, in the present example, when the device type is "air conditioner" or "water heater," the device status represents a temperature, specifically, a room temperature or a water temperature. In the present example, when the device type is "air conditioner" or "water heater", the determination unit 120 classifies logs based on the temperature represented by the device status. For example, when a first log (e.g., a log associated with a new communication log set ID) having a device type of air conditioner or water heater is acquired, the determination unit 120 uses a first temperature indicated in the device status of the first log and classifies a second log acquired after the first log based on whether a second temperature indicated by the device status of the second log differs from the first temperature by at least a predetermined temperature threshold. If the difference is at least the predetermined temperature threshold, the determination unit 120 associates different communication log set IDs with the first and second logs, for example. However, if the difference is less than the predetermined temperature threshold, the determination unit 120 associates the same communication log set ID with the first and second logs, for example.

The predetermined temperature threshold may be determined to be any value and is not limited to a particular value.

When the device status takes a plurality of values, such as room temperature or water temperature, temperature ranges may be predetermined to represent the same device status. For example, when the device status represents temperature, the temperature ranges may be predetermined as lower than 10° C., 10° C. to lower than 15° C., 15° C. to lower than 20° C., or 20° C. or higher. For example, the determination unit 120 associates the same communication log set ID to logs indicating device statuses having the same temperature range.

In addition, for example, when the device type is "lighting device", the determination unit 120 may classify logs according to whether the device status is "ON status" or "OFF status".

The relationship between device type and device status is not limited to a one-to-one correspondence. For example, when the device type is "air conditioner", the device status may include not only temperature but also ON/OFF status, airflow volume, and airflow direction. A log classification rule may be defined for each of these device statuses.

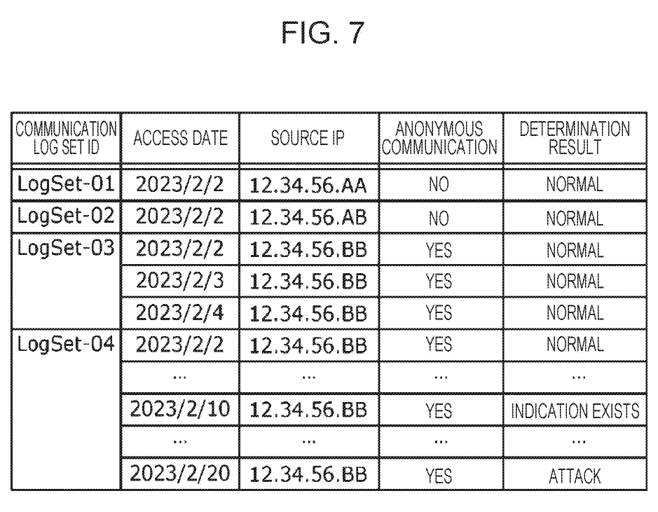

FIG. 7 illustrates an example of the attack detection result table according to the present embodiment.

The attack detection result table stores the low-and-slow attack determination result (detection result) from the attack detection unit 110 for logs associated with the same communication log set ID. The attack detection result table includes at least a communication log set ID, an access date, and a determination result. In the example illustrated in FIG. 7, the attack detection result table includes the communication log set ID, an access date (date on which access occurred), a source IP, the presence of anonymous communication, and a determination result. The determination result stores the result of the low-and-slow attack detection process for the communication performed on the access date. For example, at the end of a day, the attack detection unit 110 performs the low-and-slow attack detection process for the logs associated with the same communication log set ID as the logs acquired on that day.

"Access Date" illustrated in FIG. 7 represents the most recent date and time at which a log associated with the corresponding communication log set ID was acquired. In the present example, the "Access Date" represents the most recent date on which a low-and-slow attack detection process was performed for the log associated with the corresponding communication log set ID.

"Determination Result" illustrated in FIG. 7 represents the low-and-slow attack detection result from the attack detection unit 110. A determination result of "Normal" indicates that no low-and-slow attack was detected by the attack detection unit 110. A determination result of "Indication Present" indicates that an indication of a low-and-slow attack is detected by the attack detection unit 110. A determination result of "Attack" indicates that a low-and-slow attack is detected by the attack detection unit 110.

The determination result is presented to a user, for example, by being displayed on the display unit 140. The determination result may be displayed on the display unit 140 only when the result indicates "Attack".

### Processing Procedure

The processing procedure of the communication system 10 is described below.

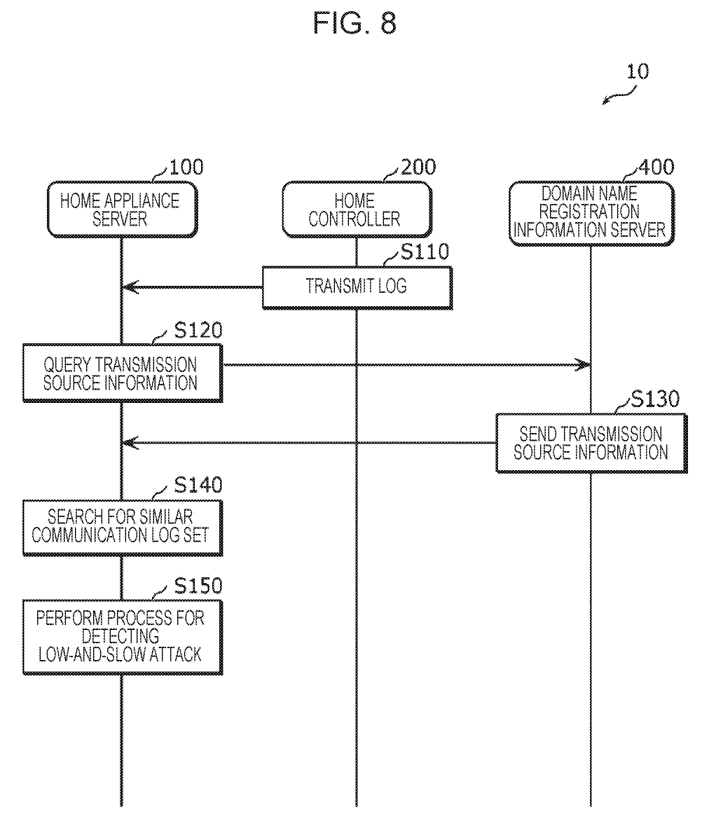

FIG. 8 is a sequence diagram illustrating the processing procedure of the communication system 10 according to the present embodiment. More specifically, FIG. 8 is a sequence diagram illustrating the processes for detecting a low-and-slow attack by the attack detection unit 110 when anonymous communication is used in the communication for controlling a home appliance communicatively connected to the home controller 200. In FIG. 8, a home appliance and the anonymous communication server 300 in the communication system 10 are not illustrated.

Upon receipt of a packet including a command, the home controller 200 performs control of a home appliance based on the command. The home controller 200 also transmits a home appliance log (communication log) to the home appliance server 100 (S110). The home controller 200 transmits the home appliance log to the home appliance server 100, for example, when the state of the home appliance changes.

The home appliance server 100 queries transmission source information that corresponds to the IP address included in the source IP field of the received log (S120). The home appliance server 100 transmits information indicating the IP address included in the source IP field of the received log to the domain name registration information server 400, for example.

Upon receipt of the transmission source information inquiry from the home appliance server 100, the domain name registration information server 400 notifies the home appliance server 100 of the transmission source information corresponding to the IP address included in the received inquiry (i.e., transmits the transmission source information to the home appliance server 100) (S130). The domain name registration information server 400, for example, transmits the transmission source information corresponding to the IP address in the received information to the home appliance server 100.

An example of the transmission source information is data indicating whether a communication device identified by an IP address included in a query to the domain name registration information server 400 corresponds to the anonymous communication server 300.

In steps S120 and S130, the home appliance server 100 communicates with the domain name registration information server 400 to obtain information indicating whether the transmission source identified by the IP address included in the source IP field of the received log corresponds to the anonymous communication server 300.

The home appliance server 100 searches for a communication log set similar to the received log (S140). More specifically, the home appliance server 100 associates a communication log set ID to the received log based on the log classification rules and the like.

The home appliance server 100 detects a low-and-slow attack based on the communication log set (S150). As described above, for example, the home appliance server 100 searches, using the communication log set table, for a communication log set containing a log similar to the received log. If such a communication log set is found, the low-and-slow attack detection process is performed on that communication log set.

The processes illustrated in FIG. 8 may be performed upon acquisition of each log, or may be performed at a predetermined time, for example, at the end of a day. For example, the home controller 200 may transmit a log indicating the execution result of the process to the home appliance server 100 each time a home appliance performs a process in response to a command. Alternatively, it may transmit one or more logs to the home appliance server 100 collectively at a predetermined time. The home appliance server 100 may execute the processes in steps S120 to S150 each time it receives a log, or may perform the processes in steps S120 to S150 for one or more logs at a predetermined time.

The predetermined time may be set to any time and is not limited to a particular time.

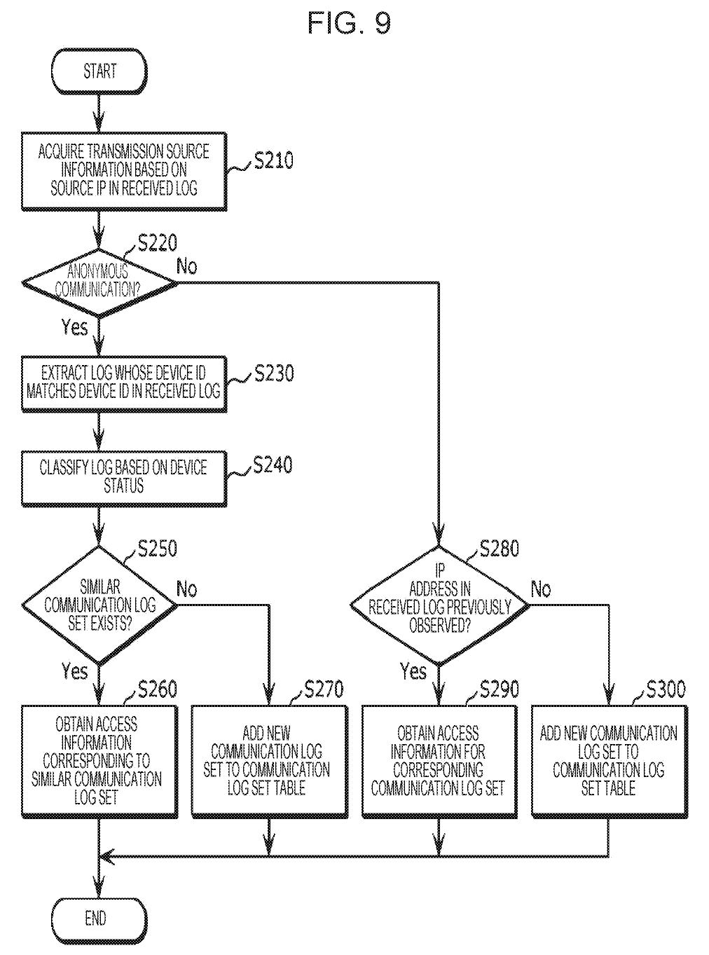

FIG. 9 illustrates a flowchart of the processing procedure of the home appliance server 100 according to the present embodiment. More specifically, FIG. 9 illustrates a flowchart detailing step S140 of FIG. 8, which is performed by the determination unit 120. For example, the flowchart illustrated in FIG. 9 is assumed to be executed in batch processing at predetermined intervals, for example, daily.

The determination unit 120 first acquires the transmission source information based on the source IP included in the received log (S210). More specifically, the transmission source information is acquired by executing the processes in steps S120 and S130.

Subsequently, the determination unit 120 determines, based on the transmission source information, whether the access to the home appliance that results in the device status indicated by the received log was performed through anonymous communication (S220). More specifically, the determination unit 120 determines whether the packet including a command to set the home appliance to the device status indicated by the received log was transmitted through anonymous communication.

If the determination unit 120 determines that anonymous communication was used, that is, the packet was transmitted through anonymous communication (Yes in S220), the determination unit 120 extracts, from the communication log set table, a log whose device ID matches the device ID in the received log (S230).

The determination unit 120 classifies the received log based on the device status of the home appliance corresponding to the device ID (S240). More specifically, the determination unit 120 first determines whether a communication log set that includes a log similar to the received log (also simply referred to as a similar communication log set) exists (S250). More specifically, the determination unit 120 determines whether a log including a device status similar to that included in the received log exists in the logs extracted in step S230. Whether the logs are similar is determined based on the log classification rules, for example. If the determination unit 120 determines that a similar communication log set exists (Yes in S250), the determination unit 120 obtains, from the access information table, the access information corresponding to the similar communication log set (S260). In addition, the determination unit 120 associates the communication log set ID of the similar communication log set with the received log.

However, if the determination unit 120 determines that no communication log set similar to the received log exists (No in S250), the determination unit 120 adds a new communication log set including the received log to the communication log set table (S270). That is, the determination unit 120 associates a communication log set ID that is not in the communication log set table with the received log. As described above, the determination unit 120 classifies the received log by searching for a past log that is similar to the received log and associating the communication log set ID with the received log based on the search result.

If, in step S220, the determination unit 120 determines that anonymous communication is not used, that is, the packet including a command to set the home appliance to the device status indicated by the received log was not transmitted through anonymous communication (No in S220), the determination unit 120 determines, based on the communication log set table, whether the IP address included in the source IP field of the received log has previously been observed (S280). That is, the determination unit 120 determines whether the source IP appears in logs received prior to the current log.

If the determination unit 120 determines that the source IP has previously been observed (Yes in S280), the determination unit 120 obtains, from the access information table, the access information for the corresponding communication log set, i.e., the communication log set that contains a log with the same source IP as the received log (S290). In addition, the determination unit 120 associates the communication log set ID of the communication log set with the received log. However, if the determination unit 120 determines that the source IP has not been observed (No in S280), the determination unit 120 adds, to the communication log set table, a new communication log set including the received log (S300). That is, the determination unit 120 associates a communication log set ID that does not appear in the communication log set with the received log. As described above, even when the communication is not anonymous, the determination unit 120 classifies the received log by associating a communication log set ID with the received log based on the source IP.

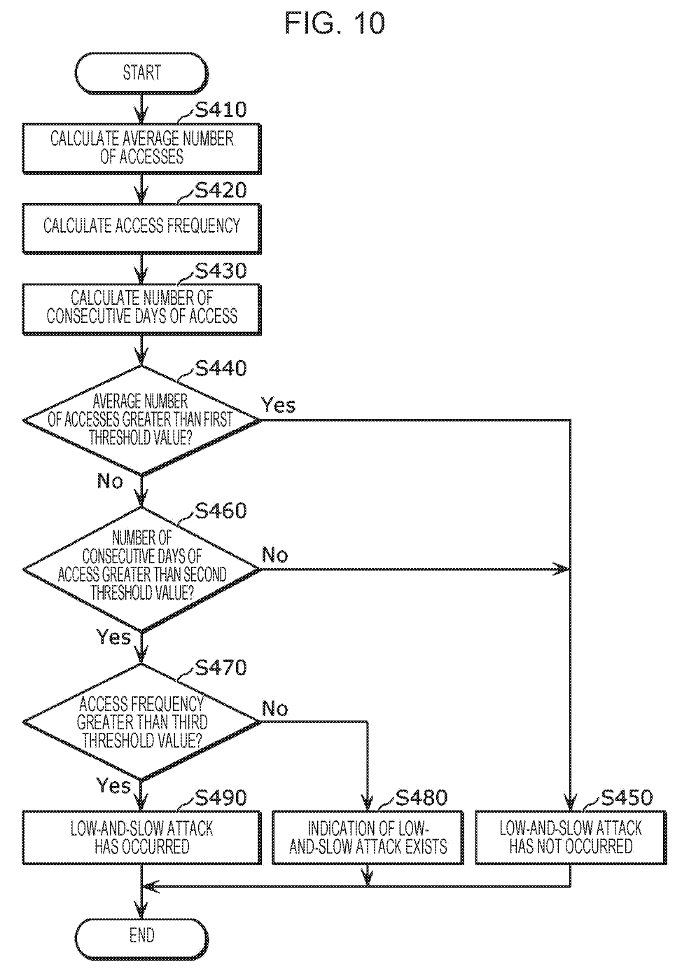

FIG. 10 illustrates a flowchart of the processing procedure for low-and-slow attack detection performed by the home appliance server 100 according to the present embodiment. More specifically, FIG. 10 illustrates a flowchart detailing step S150 of FIG. 8, which is performed by the attack detection unit 110. For example, at the end of a day, the attack detection unit 110 performs the process illustrated in FIG. 10 for a communication log set, among the one or more communication log sets, to which a new log has been added.

The determination unit 120 first calculates the average number of accesses based on one or more logs included in the communication log set (S410). The determination unit 120 then calculates the access frequency (S420) and the number of consecutive days of access (S430) based on the same logs.

Steps S410 to S430 may be executed in any order. After executing steps S410 to S430, for example, the determination unit 120 updates the access information table based on the calculation results obtained from the steps.

Subsequently, the attack detection unit 110 performs the following steps S440 to S490 based on the average number of accesses, the access frequency, and the number of consecutive days of access calculated in steps S410 to S430.

The attack detection unit 110 determines whether the calculated average number of accesses is greater than the first threshold value (S440).

If the attack detection unit 110 determines that the calculated average number of accesses is greater than the first threshold value (Yes in S440), the attack detection unit 110 determines that a low-and-slow attack has not occurred (S450). That is, the attack detection unit 110 determines that each log included in the communication log set does not indicate control information corresponding to a command in a packet transmitted in a low-and-slow attack.

However, if the attack detection unit 110 determines that the calculated average number of accesses is less than or equal to the first threshold value (No in S440), the attack detection unit 110 determines whether the calculated number of consecutive days of access is greater than the second threshold value (S460).

If the attack detection unit 110 determines that the calculated number of consecutive days of access is less than or equal to the second threshold value (No in S460), the attack detection unit 110 determines that a low-and-slow attack has not occurred (S450).

However, if the attack detection unit 110 determines that the calculated number of consecutive days of access is greater than the second threshold value (Yes in S460), the attack detection unit 110 determines whether the access frequency is greater than the third threshold value (S470).

If the attack detection unit 110 determines that the access frequency is less than or equal to the third threshold value (No in S470), the attack detection unit 110 determines that an indication of a low-and-slow attack exists (S480). That is, the attack detection unit 110 determines that each log in the communication log set may indicate control information corresponding to a command in a packet transmitted in a low-and-slow attack.

If the attack detection unit 110 determines that the access frequency is greater than the third threshold value (Yes in S470), the attack detection unit 110 determines that a low-and-slow attack has occurred (S490). That is, the attack detection unit 110 determines that each log in the communication log set indicates control information corresponding to a command in a packet transmitted in a low-and-slow attack.

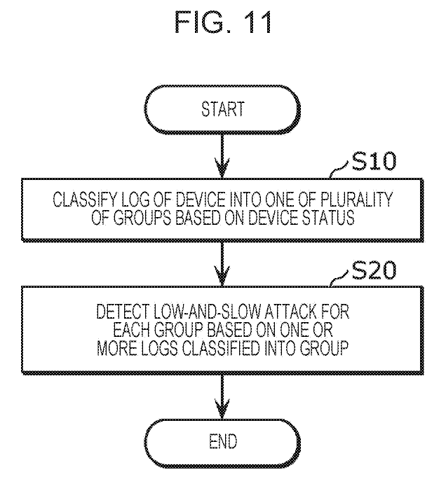

FIG. 11 illustrates a flowchart of an information processing method according to the present embodiment.

For example, an information processing apparatus includes a processor and a memory. An example of the information processing apparatus is the home appliance server 100 described above.

The information processing apparatus first classifies a log of a device into one of a plurality of groups based on a device status that indicates a state of the device controlled by a command included in a communication packet (S10). For example, the information processing apparatus acquires, from an apparatus (e.g., the home controller 200) that collects logs of a device (e.g., a home appliance) in a home network, a plurality of logs and classifies each log into one of a plurality of groups. The information processing apparatus may alternately acquire the logs from a storage device (e.g., the storage unit 150).

An example of a communication packet is a packet transmitted to the home controller 200 to control a device from the outside. The communication packet may be transmitted directly to the device, or may be transmitted to the home controller 200 or the device via the anonymous communication server 300 or the like.

An example of a device is a home appliance (e.g., the air conditioner 210). The device may be any device that can be controlled via communication and is not limited to a home appliance. The log of the device may be, for example, information indicating control executed by the device, control executed under the control of the home controller 200, or control corresponding to a command included in a communication packet.

An example of a group is the communication log set described above.

Subsequently, the information processing apparatus detects a low-and-slow attack for each group of the plurality of groups based on one or more logs classified into the group (S20). More specifically, for each group into which the device logs are classified, the information processing apparatus determines whether the one or more logs included in the group indicate control information corresponding to a command included in a communication packet transmitted in a low-and-slow attack.

The information processing apparatus displays the result of the low-and-slow attack detection on a display device, such as a monitor. This enables the user to confirm whether a low-and-slow attack has occurred.

### Effects

Techniques disclosed from the present specification are described below as examples, and their effects and advantages are also described.

In Technique 1, an information processing method is provided that includes classifying a log of a device into one of a plurality of groups based on a device status indicating the state of the device controlled by a command included in a communication packet (S10) and detecting a low-and-slow attack for each group of the plurality of groups based on one or more logs classified into the group (S20).

According to Technique 1, a low-and-slow attack is detected from the result of log classification based on device status. Therefore, a low-and-slow attack can be detected irrespective of the source IP address. Even if, for example, anonymous communication is used and therefore a plurality of transmission sources share the same IP address or the same transmission source uses different IP addresses, the logs can be classified into one of a plurality of groups based on the device status, and a low-and-slow attack can be detected for each classified group. A low-and-slow attack is considered to be performed by repeatedly transmitting communication packets including the same command. Therefore, a device under a low-and-slow attack tends to repeatedly execute the same control. By detecting a low-and-slow attack for each group based on logs classified according to device status, a low-and-slow attack can be detected with high accuracy.

In Technique 2, the information processing method described in Technique 1 further includes determining whether the communication packet is transmitted through anonymous communication. If it is determined that the communication packet is transmitted through anonymous communication, the log of the device is classified into any one of the plurality of groups based on the device status.

According to Technique 2, since anonymous communication is used, logs are classified based on the device status, and a low-and-slow attack is detected with high accuracy, even when a plurality of transmission sources share the same IP address or the same transmission source uses different IP addresses.

In Technique 3, to detect a low-and-slow attack, the information processing method described in Technique 1 or 2 determines, based on one or more logs classified into respective groups, whether a low-and-slow attack has occurred, whether an indication of a low-and-slow attack exists, or whether a low-and-slow attack has not occurred.

According to Technique 3, a low-and-slow attack can be detected. Determining whether an indication of a low-and-slow attack exists enables notification to the user at an early stage, even when it is difficult to determine whether the attack is a low-and-slow attack.

In Technique 4, in the detecting a low-and-slow attack, the information processing method described in any one of Techniques 1 to 3 detects a low-and-slow attack based on at least one of an average number of accesses to the device per day, a number of consecutive days of access to the device, or an access frequency to the device, each calculated from one or more logs classified into respective groups.

According to Technique 4, a low-and-slow attack can be detected with high accuracy.

In Technique 5, in the detecting a low-and-slow attack, the information processing method described in Technique 4 determines that a low-and-slow attack has not occurred if the average number of accesses is greater than the first threshold value.

According to Technique 5, a low-and-slow attack can be detected with high accuracy.

In Technique 6, in the detecting a low-and-slow attack, the information processing method described in Technique 4 or 5 determines that a low-and-slow attack has not occurred if the number of consecutive days of access is less than or equal to a second threshold value.

According to Technique 6, a low-and-slow attack can be detected with high accuracy.

In Technique 7, in the detecting a low-and-slow attack, the information processing method described in any one of Techniques 4 to 6 determines that a low-and-slow attack has occurred or an indication of a low-and-slow attack exists if the average number of accesses is less than or equal to the first threshold value and the number of consecutive days of access is greater than the second threshold value.

According to Technique 7, a low-and-slow attack can be detected with high accuracy.

In Technique 8, in the detecting a low-and-slow attack, the information processing method described in Technique 7 determines that a low-and-slow attack has occurred if the access frequency is greater than a third threshold value and determines that an indication of a low-and-slow attack exists if the access frequency is less than or equal to the third threshold value.

According to Technique 8, a low-and-slow attack can be detected with high accuracy.

In Technique 9, an information processing apparatus is provided that includes a classification unit that classifies a log of a device into one of a plurality of groups based on a device status that indicates a state of the device controlled by a command included in a communication packet, and a detection unit that detects a low-and-slow attack for each group of the plurality of groups based on one or more logs classified into the group.

The classification unit is, for example, the determination unit 120 described above. The detection unit is, for example, the attack detection unit 110 described above. The information processing apparatus is, for example, the home appliance server 100 described above.

According to Technique 9, the effect is the same as that of the information processing method according to one aspect of the present disclosure.

In Technique 10, a program is provided that causes a computer to execute the information processing method described in any one of Techniques 1 to 8.

According to Technique 10, the effect is the same as that of the information processing method according to the aspect of the present disclosure.

### Other Embodiments

While the present disclosure has been described with reference to the embodiments described above, the present disclosure is not limited thereto.

For example, while the embodiment above has been described with reference to the home appliance server 100 functioning as the information processing apparatus, any one of the apparatuses in the communication system 10 may detect a low-and-slow attack. For example, the home controller 200 may detect a low-and-slow attack, or a device such as the air conditioner 210 or the lighting device 220 may detect a low-and-slow attack.

For example, the information processing apparatus according to the above embodiment may be implemented as a single apparatus including all constituent elements or as a plurality of apparatuses each having a subset of functions and operating together.

According to the embodiment described above, the process executed by a particular processing unit may be executed by another processing unit. The order of the plurality of processes may be changed, and the plurality of processes may be executed in parallel.

Each of the constituent elements in the above-described embodiment may be implemented by executing a software program suitable for the constituent element. The constituent element may be implemented by a program execution unit, such as a CPU or processor, which reads and executes a software program recorded on a storage medium, such as a hard disk or semiconductor memory.

Alternatively, each of the constituent elements may be implemented by hardware. For example, the constituent element may be realized as a circuit (or integrated circuit). These circuits may form a single circuit as a whole, or may be provided as separate circuits. Each of these circuits may be a general-purpose circuit or a dedicated circuit.

The general or specific aspect of the present disclosure may be implemented by an apparatus, system, method, integrated circuit, computer program, or non-transitory computer-readable storage medium, such as a CD-ROM. The general or specific aspect of the present disclosure may also be realized in any combination of an apparatus, system, method, integrated circuit, computer program, and storage media.

Embodiments to which various modifications conceived by those skilled in the art are applied, or embodiments formed by combining the constituent elements and functions of the embodiments, without departing from the spirit of the present disclosure, fall within the scope of the present disclosure.

The present disclosure is useful for computers that store logs of an IoT device.

What is claimed is:

1. An information processing method comprising:
classifying a log of a device into one of a plurality of groups based on a device status that indicates a state of the device controlled by a command included in a communication packet; and
detecting a low-and-slow attack for each group of the plurality of groups based on one or more logs classified into the group.

2. The information processing method according to claim 1, further comprising:
determining whether the communication packet is transmitted through anonymous communication,
wherein if it is determined that the communication packet is transmitted through anonymous communication, the log of the device is classified into one of the plurality of groups based on the device status.

3. The information processing method according to claim 1, wherein, in the detecting a low-and-slow attack, based on the one or more logs classified into respective groups, a determination is made as to whether a low-and-slow attack has occurred, whether an indication of a low-and-slow attack exists, or whether a low-and-slow attack has not occurred.

4. The information processing method according to claim 1, wherein, in the detecting a low-and-slow attack, the low-and-slow attack is detected based on at least one of an average number of accesses to the device per day, a number of consecutive days of access to the device, or an access frequency to the device, each calculated from one or more logs classified into the respective groups.

5. The information processing method according to claim 4, wherein, in the detecting a low-and-slow attack, if the average number of accesses is greater than a first threshold value, it is determined that a low-and-slow attack has not occurred.

6. The information processing method according to claim 4, wherein, in the detecting a low-and-slow attack, if the number of consecutive days of access is less than or equal to a second threshold value, it is determined that a low-and-slow attack has not occurred.

7. The information processing method according to claim 4, wherein, in the detecting a low-and-slow attack, if the average number of accesses is less than or equal to a first threshold value and the number of consecutive days of access is greater than a second threshold value, it is determined that a low-and-slow attack has occurred or an indication of a low-and-slow attack exists.

8. The information processing method according to claim 7, wherein, in the detecting a low-and-slow attack, if the access frequency is greater than a third threshold value, it is determined that a low-and-slow attack has occurred, and
wherein if the access frequency is less than or equal to the third threshold value, it is determined that an indication of a low-and-slow attack exists.

9. An information processing apparatus comprising:
a classifier that classifies a log of a device into one of a plurality of groups based on a device status that indicates a state of the device controlled by a command included in a communication packet; and
a detector that detects a low-and-slow attack for each group of the plurality of groups based on one or more logs classified into the group.

10. A non-transitory computer-readable storage medium storing one or more programs including executable instructions that, when executed by a computer, cause the computer to perform the information processing method according to claim 1.
